(19) United States
(12) Patent Application Publication
(10) Pub. No.: US 2017/0212869 A1
(43) Pub. Date: Jul. 27, 2017

(54) Document Viewing System and Non-Transitory Computer Readable Recording Medium

(71) Applicant: Konica Minolta, Inc., Tokyo (JP)

(72) Inventor: Koichi Tashiro, Tokyo (JP)

(73) Assignee: Konica Minolta, Inc., Tokyo (JP)

(21) Appl. No.: 15/410,519

(22) Filed: Jan. 19, 2017

(30) Foreign Application Priority Data
Jan. 21, 2016 (JP) 2016-010129

(51) Int. Cl. G06F 17/21; G06F 3/14

(52) U.S. Cl. CPC G06F 17/212; G06F 17/218; G06F 3/1462

(57) ABSTRACT

Disclosed is a document viewing system including: a document dividing unit configured to analyze a format of a document to be displayed in a reflow display, divide the document into predetermined elements, and prepare a second document by adding identifiers to the elements; and a plurality of display terminals configured to display the second document in the reflow display, wherein the first display terminal creates specific information for specifying a part of the second document, which is currently displayed on the first display terminal, in accordance with the identifiers added in the second document, and outputs the specific information to an external device, and the second display terminal receives the specific information, specifies the part which is currently displayed on the first display terminal in accordance with the specific information, and displays the second document so as to make a viewer recognize the specified part.

### CROSS-REFERENCE TO RELATED APPLICATIONS

This U.S. patent application is entitled to and claims the benefit of Japanese Patent Application No. 2016-010129, filed on Jan. 21, 2016, the entire contents of which is incorporated herein by reference, including for any correction of incorrect translation.

### BACKGROUND OF THE INVENTION

Field of the Invention

The present invention relates to a document viewing system and a non-transitory computer-readable recording medium for displaying the same document on a plurality of viewing terminals by reflowing the contents of the document.

Description of Related Art

In recent years, the digitization of paper documents and the mobilization of computers have been rapidly advanced. Many electronic documents are viewed by using a mobile terminal, such as a tablet PC, a smart phone or the like. However, because the display screen (display) of each mobile terminal is comparatively small, it is necessary to frequently perform a scroll operation or a pinch-in/out operation when the document is viewed.

Therefore, as a document viewing method for reducing the number of times of the scroll operation or the pinch-in/out operation, the document is displayed by reflowing the contents of the document (reflow display). In the reflow display, the size of each character, the space between the lines, the number of characters in one line and the like are automatically adjusted according to the size of the display screen of the terminal. For example, FIG. 23 shows each example of the reflow display in which the original document which is written horizontally is displayed on the terminal A arranged rectangularly and is displayed on the terminal B arranged laterally and having the display screen which is smaller than that of the terminal A. Even in the terminal B having a small display screen, the character size does not become smaller and the document can be displayed readably.

As the mobile terminals are popularized, in the conference, there are many cases in which a presenter and participants view the document by using each terminal. In this case, it is preferable that each participant can easily find the part of the document, which is indicated by the presenter from the document displayed on the participant's terminal to display the above part.

For example, in Japanese Patent Application Publication No. 2005-318589, the technology for transmitting the window displayed on one terminal to another terminal by capturing the displayed window is disclosed. Further, in Japanese Patent Application Publication No. 2015-149042, the following technology is displayed. In this technology, the part of the document, which is viewed by many users is specified. When each user performs the operation for approaching the specified part in the display screen, moving the displayed area in accordance with the above operation is smoothly carried out. On the other hand, when each user performs the operation for receding from the specified part in the display screen, moving the displayed area in accordance with the above operation is delayed. Therefore, each user is introduced to the part which is viewed by many users.

As described above, in the reflow display, the number of characters in one line and the like are changed according to the size of the display screen of the terminal and the like. Therefore, it is possible to display the document at the readable character size regardless of the size of the display screen of each terminal. However, as a case in which the reflow display is disadvantageous, there is a case in which a plurality of participants views the same document by using each terminal in a conference or the like.

Specifically, when each participant of the conference views the same document used in the conference by displaying the document in the reflow display on each terminal, such as a PC, a mobile terminal or the like, because the size of the display screen of one terminal is different from that of another terminal, the appearance (layout, the number of pages and the like) of the document is different according to each terminal. Therefore, even if a presenter of the conference indicates the specific part of the document based on the display state of the presenter's terminal, there is some possibility that it is difficult for the participants to find and display the specific part by using each participant's terminal.

Specifically, as shown in FIG. 24, even if the presenter asks the participants to see the drawing below the word “Abc [symbol] ” described in the third page of the document, each participant cannot immediately recognize the position of the above drawing in the display state of each participant's terminal. Each participant needs time for finding the above drawing on his/her terminal. Therefore, when each participant finds the above drawing, the presenter's explanation has been advanced and is not sufficient for each participant to understand the contents thereof. Alternatively, when the conference proceeds so as to start the presenter's explanation relating to the above drawing after each participant found the above drawing in each terminal, the progress of the conference is hindered. As a result, much time is wasted.

Each of the technologies disclosed in Japanese Patent Application Publications No. 2005-318589 and No. 2015-149042 does not relate the reflow display. Therefore, the above problem cannot be solved by the above technologies.

### SUMMARY

To achieve at least one of the abovementioned objects, a document viewing system reflecting one aspect of the present invention, comprises:
a document dividing unit configured to analyze a format of a document to be displayed in a reflow display, divide the document into predetermined elements, and prepare a second document by adding identifiers to the elements; and
a plurality of display terminals configured to display the second document in the reflow display, the plurality of display terminals including a first display terminal and a second display terminal,
wherein the first display terminal creates specific information for specifying a part of the second document, which is currently displayed on the first display terminal, in accordance with the identifiers added in the second document, and outputs the specific information to an external device, and
the second display terminal receives the specific information, specifies the part which is currently displayed on the first display terminal in accordance with the specific information, and displays the second document so as to make a viewer recognize the specified part.

Preferably, the document dividing unit prepares the second document in which unique identifiers are added to the elements, and
the first display terminal outputs the unique identifier added to each element in the part which is currently displayed on the first display terminal, as the specific information.

Preferably, the second display terminal highlights the part specified in accordance with the specific information, to make the viewer recognize the specified part.

Preferably, the second display terminal moves a second part of the second document, which is displayed on the second display terminal, to the part specified in accordance with the specific information, to make the viewer recognize the specified part.

Preferably, when the second display terminal receives an operation for moving the second part displayed on the second display terminal from the viewer, the second display terminal automatically moves the second part displayed on the second display terminal to the part specified in accordance with the specific information.

Preferably, every when the second display terminal receives the specific information, the second display terminal automatically move the second part of the second document, which is displayed on the second display terminal, to the part specified in accordance with the specific information.

Preferably, the document dividing unit divides the document by recognizing the elements from tag information for defining a structure of the document.

Preferably, after the part of the document, which is displayed on the first display terminal is moved, when the moved part continues to be displayed for a predetermined period of time, the first display terminal creates and outputs the specific information.

Preferably, the display terminal which functions as the first display terminal is switched to another display terminal among the plurality of display terminals.

Preferably, the document viewing system further comprises a restoring unit configured to restore the document by deleting the identifiers added in the second document.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a view showing the configuration of the document viewing system according to the first embodiment;

FIG. 2 is a block diagram showing the schematic configuration of the server;

FIG. 3 is a block diagram showing the schematic configuration of the display terminal;

FIG. 4 is a view showing an example of document data which is displayed in the reflow display;

FIG. 5 is a view showing the data of the second document, which is obtained by adding the unique identifiers in the document data shown in FIG. 4;

FIG. 6 is a flowchart showing the process for viewing the document, which is carried out by the server;

FIG. 7 is a flowchart showing the process for switching the permission between the presentation and the viewing, which is carried out by the display terminal;

FIG. 8 is a flowchart showing the process which is carried out by the display terminal which becomes the presentation terminal;

FIG. 9 is a flowchart showing the process which is carried out by the display terminal which becomes the viewing terminal;

FIG. 10 is a view showing the initial situation in which the second document is displayed on the terminal A;

FIG. 11 is a view showing the situation in which the terminal A becomes the presentation terminal;

FIG. 12 is a view showing the situation in which the terminal B becomes the viewing terminal;

FIG. 13 is a view showing the situation in which the terminal C becomes the viewing terminal;

FIG. 14 is a view showing the situation after the displayed part is changed in the terminal A;

FIG. 15 is a view showing the situation of the terminal B in which the highlighted part is changed according to the part which is currently displayed on the display terminal A shown in FIG. 14;

FIG. 16 is a view showing the situation of the terminal C in which the highlighted part is changed according to the part which is currently displayed on the display terminal A shown in FIG. 14;

FIG. 17 is a view showing the situation of the terminal B in which the displayed part is automatically moved to the highlighted part by pressing down the move button in the situation shown in FIG. 15;

FIG. 18 is a view showing the situation of the terminal B which is switched to the presentation terminal by pressing down the permission switching button of the terminal B in the situation shown in FIG. 15;

FIG. 19 is a view showing the situation of the terminal A which is switched to the viewing terminal;

FIG. 20 is a view showing the situation of the terminal C in which the highlighted part is changed according to the part which is currently displayed on the display terminal B shown in FIG. 18;

FIG. 21 is a view showing the configuration of the document viewing system according to the second embodiment;

FIG. 22 is a block diagram showing the schematic configuration of the display terminal included in the document viewing system according to the second embodiment;

FIG. 23 is a view showing each example of the reflow display in which the original document which is written horizontally is displayed on the terminal A arranged rectangularly and is displayed on the terminal B arranged laterally and having the display screen which is smaller than that of the terminal A; and

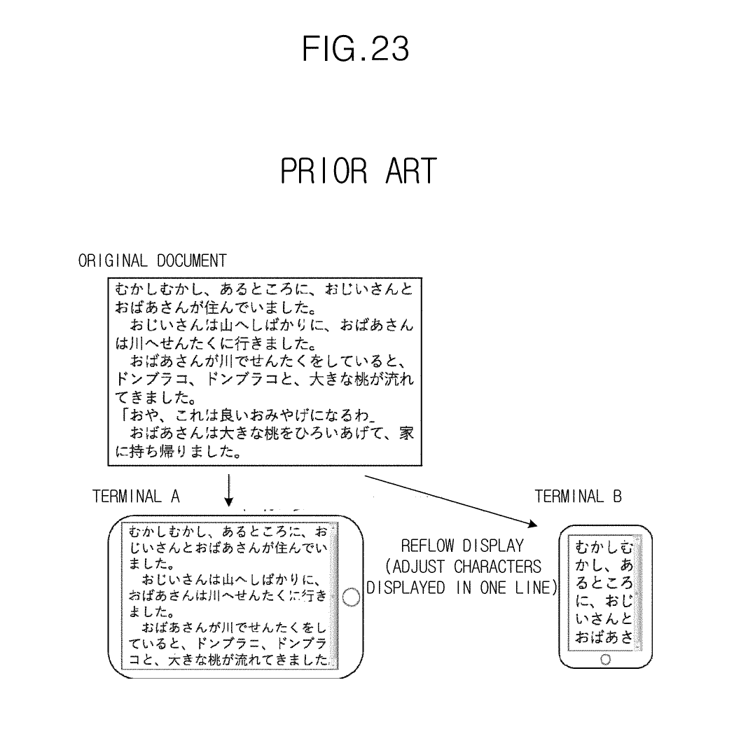

FIG. 24 is a view showing an example of the case in which the presenter of the conference indicates the specified part of the document, which is displayed on the presenter's terminal.

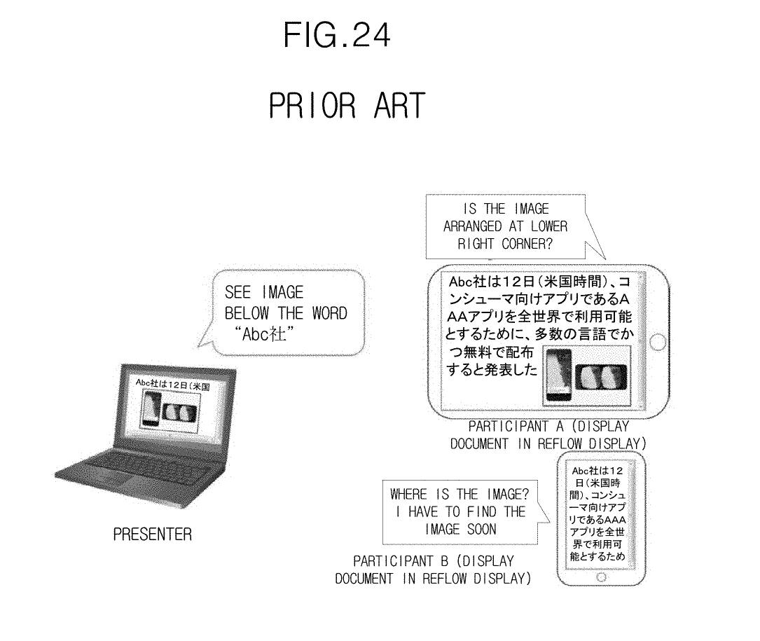

### DETAILED DESCRIPTION

Hereinafter, preferred embodiments of the present invention will be explained with reference to the accompanying drawings.

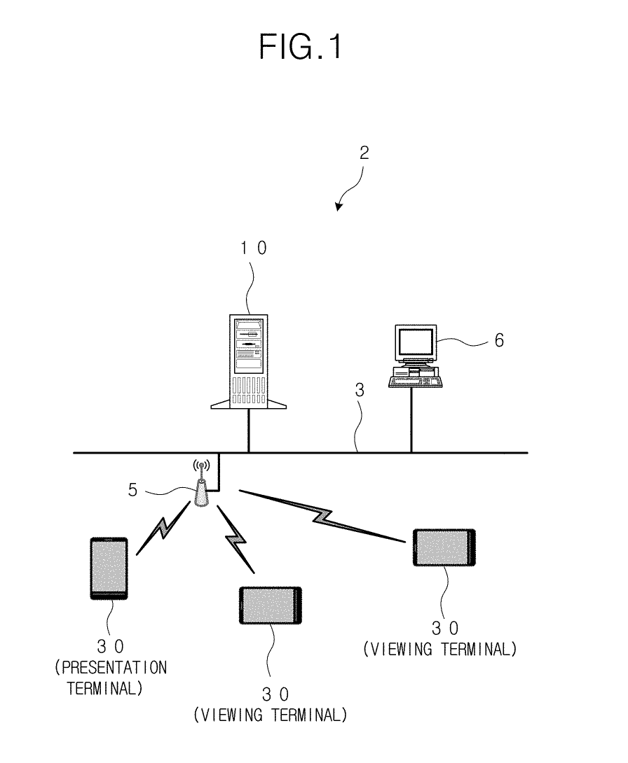

FIG. 1 is a view showing the configuration example of the document viewing system 2 according to the first embodiment. The document viewing system 2 comprises a server 10 and a plurality of display terminals 30 which are connected to each other via a network 3, such as LAN (Local Area Network). Each display terminal 30 is a mobile terminal, such as a portable PC, a tablet or the like. For example, each display terminal 30 is connected to the network 3 via an access point 5 by using the wireless communication. In this embodiment, in the network 3, a personal computer 6 is connected. Each display terminal 30 has the function for displaying the document in the reflow display. In the reflow display, the size of each character, the space between the lines, the number of characters in one line and the like are automatically adjusted according to the size of the display screen of the display terminal 30.

The document viewing system 2 is used when each participant views the same document, such as the document used in the conference or the like, by using each display terminal 30 in the conference or the like. In the document viewing system 2, the document prepared by the personal computer 6, the display terminal 30 or the like is uploaded to the server 10. The document is a document which is suitable for the reflow display. In this document, the page break and the layout of the page (the number of characters in one line, the number of lines in one page, and the like) are not set. For example, this document is a structured document, such as the OOXML (Office Open XML) or the like.

The server 10 analyzes the format of this document, divides the document into the elements (for example, clauses, images or the like) in accordance with the tag information or the like, and prepares the second document by adding the unique identifiers (for example, serial numbers or the like) to the above elements.

Each display terminal 30 downloads the second document from the server 10 and displays the second document in the reflow display. At this time, one of the display terminals 30 is set to the presentation terminal and the other display terminals 30 are set to the viewing terminals. In accordance with the user's instruction, the presentation terminal can be appropriately switched to the viewing terminal and the viewing terminal can be appropriately switched to the presentation terminal.

When the presentation terminal displays the second document, the presentation terminal creates the specific information for specifying the part of the second document, which is currently displayed on the presentation terminal, in accordance with the unique identifiers added in the second document, and outputs the specific information to an external device. In this embodiment, the presentation terminal outputs the created specific information to the server 10. Each viewing terminal receives the specific information output from the presentation terminal via the server 10. Then, each viewing terminal specifies the part of the second document, which is currently displayed on the presentation terminal, in accordance with the specific information, and displays the second document so as to make a viewer recognize the specified part. For example, the viewing terminal carries out the process for highlighting the specified part or automatically moving the displayed part so as to display the specified part.

Therefore, in the document viewing system 2, when each of the participants views the document by displaying the document relating to the conference or the like in the reflow display on each display terminal 30, it is possible to easily find and display the part which is currently displayed on the presentation terminal, on each viewing terminal.

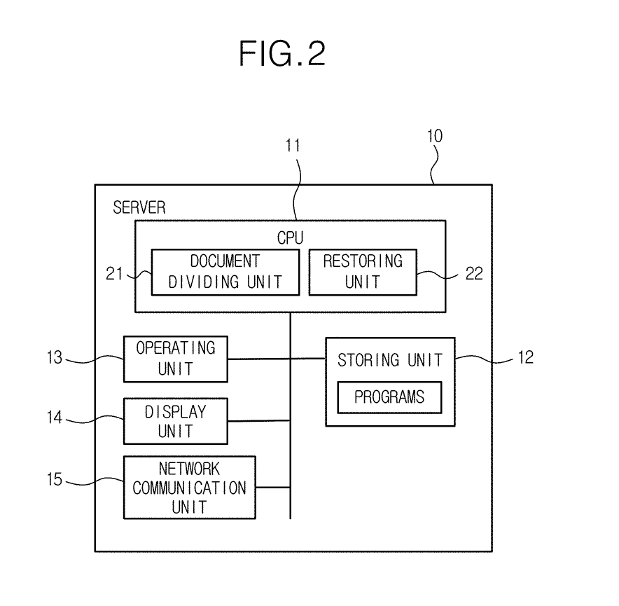

FIG. 2 is a block diagram showing the schematic configuration of the server 10. The server 10 comprises a CPU (Central Processing Unit) 11 including a microprocessor. The CPU 11 is connected with a storing unit 12 including a RAM (Random Access Memory), a ROM (Read Only Memory), a nonvolatile memory, a hard disk drive and the like, an operating unit 13, such as a keyboard, a mouse and the like for receiving the user's operation, a display unit 14, such as a liquid crystal display or the like, a network communication unit 15 for communicating with the display terminals 30 and another external device via the network 3, and the like.

By the CPU 11, a middleware, application programs and the like are executed on an OS (Operating System) program as a base.

In the storing unit 12, various types of programs are stored. By executing various types of processes by the CPU 11 in accordance with the programs, each function of the server 10 is realized.

The CPU 11 functions as the document dividing unit 21, the restoring unit 22 and the like by executing the programs stored in the storing unit 12. The document dividing unit 21 has the function for preparing the second document by analyzing the format of the document, dividing the document into the elements and adding the unique identifiers to the elements in accordance with the division step of the program executed by the CPU 11. The restoring unit 22 has the function for restoring the original document by deleting the unique identifiers from the second document in accordance with the restoring step of the program executed by the CPU 11. In addition, the CPU 11 has the function for outputting the restored original document to an external device in accordance with the restored document output step of the program and the function for distributing the second document to each display terminal 30 in accordance with the transmission step of the program. Further, the CPU 11 has the function for transmitting the specific information received from the presentation terminal to each viewing terminal, and managing the setting of each display terminal 30 to the presentation terminal or the viewing terminal and the switching of the presentation terminal and the viewing terminal in accordance with each step of the program.

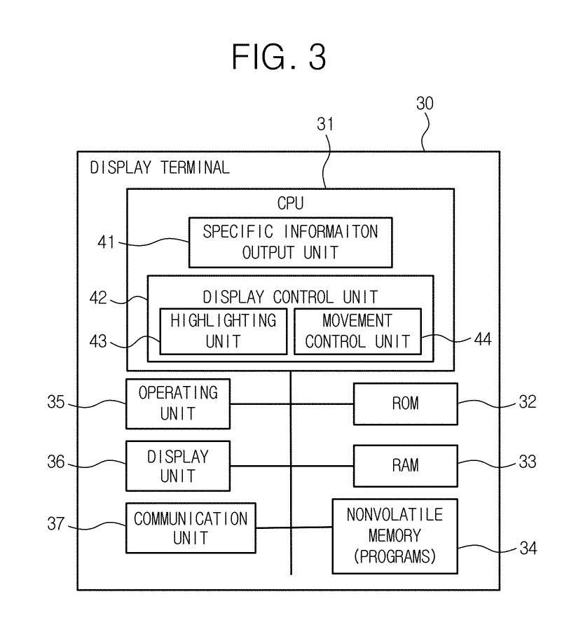

FIG. 3 shows an example of the schematic configuration of the display terminal 30. The display terminal 30 comprises a CPU 31 including a microprocessor, a ROM 32, a RAM 33, a nonvolatile memory 34, an operating unit 35 a display unit 36, a communication unit 37 and the like which are connected with each other.

By the CPU 31, a middleware, application programs and the like are executed on an OS program as a base. In the ROM 32 and the nonvolatile memory 34, various types of programs are stored. By executing various types of processes by the CPU 31 in accordance with the programs, each function of the display terminal 30 is realized.

The RAM 33 is used as a work memory for temporarily storing various data when the CPU 31 executes the process in accordance with the programs. The display unit 36 is a liquid crystal display or the like. The operating unit 35 includes a touch panel provided on the display screen of the display unit 35, some switches and the like. The touch panel detects the position on which the display screen is touched by using a finger, a pen or the like.

The communication unit 37 has the function for communicating with the server 10 and another external device via the network 3.

The CPU 31 of the display terminal 30 has the function for obtaining the second document from an external device in accordance with the obtaining step of the program stored in the nonvolatile memory 34 and executed by the CPU 31. Further, the CPU 31 functions as the specific information output unit 41 and the display control unit 42 and the like by executing the program stored in the nonvolatile memory 34. The function of the specific information output unit 41 can be realized in accordance with the specific information outputting step of the program executed by the CPU 31. When the display terminal 30 is set to the presentation terminal and displays the second document in which the unique identifiers are added, the specific information output unit 41 creates the specific information for specifying the part of the second document, which is currently displayed on the display unit 36 of the display terminal 30, in accordance with the unique identifiers added in the second document, and outputs the created specific information to an external device (in this embodiment, the created specific information is transmitted to the server 10).

When the display terminal 30 is set to the viewing terminal and displays the second document, the display control unit 42 specifies the part of the second document, which is currently displayed on the presentation terminal, in accordance with the specific information received from the server 10, and displays the second document on the display unit 36 so as to make a viewer recognize the specified part. In detail, the display control unit 42 functions as the highlighting unit 43 and the movement control unit 44.

The highlighting unit 43 highlights the part specified in accordance with the specific information, in the display format which is different from that of another part. For example, the character color of the specified part is changed. In case of an image, the image is displayed by adding the frame. The background color of the specified part is changed.

The movement control unit 44 carries out the process for moving the displayed part to the part specified in accordance with the specific information. In this embodiment, the movement control unit 44 moves the displayed part to the area which can be displayed on the display unit 36 from the head of the part specified in accordance with the specific information. The displayed part of the viewing terminal is automatically moved so as to follow the change in the displayed part of the presentation terminal. Alternatively, the displayed part of the viewing terminal is moved when the viewing terminal receives the user's instruction for stating the movement of the displayed part (when the move button is pressed down).

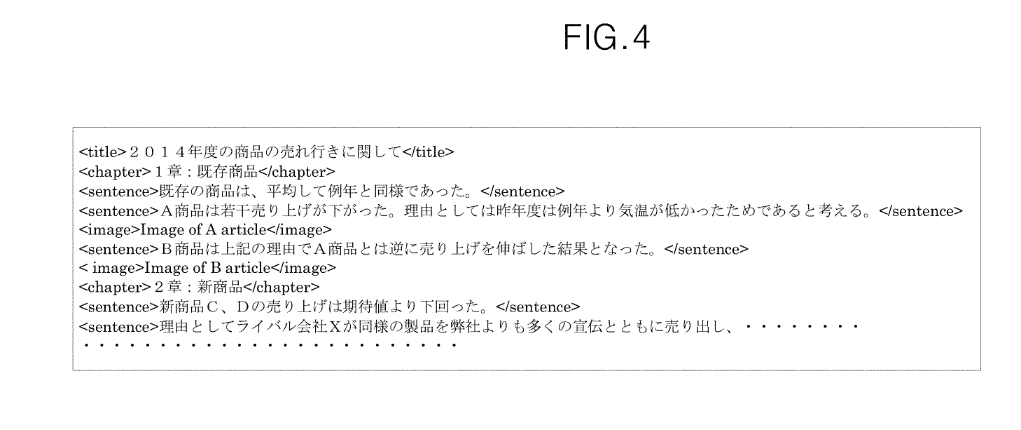

FIG. 4 shows an example of the document data which is displayed in the reflow display. This document is described in the XML syntax. In the tags, “title”, “chapter”, “sentence”, “image” and the like are included. The part enclosed by the tags is the element of the document (the object which is actually displayed as the document).

The document dividing unit 21 of the server 10 analyzes the XML syntax, recognizes the elements of the document from the tag information for defining the structure of the document, divides the document to the recognized elements and adds the unique identifiers to the elements of the document.

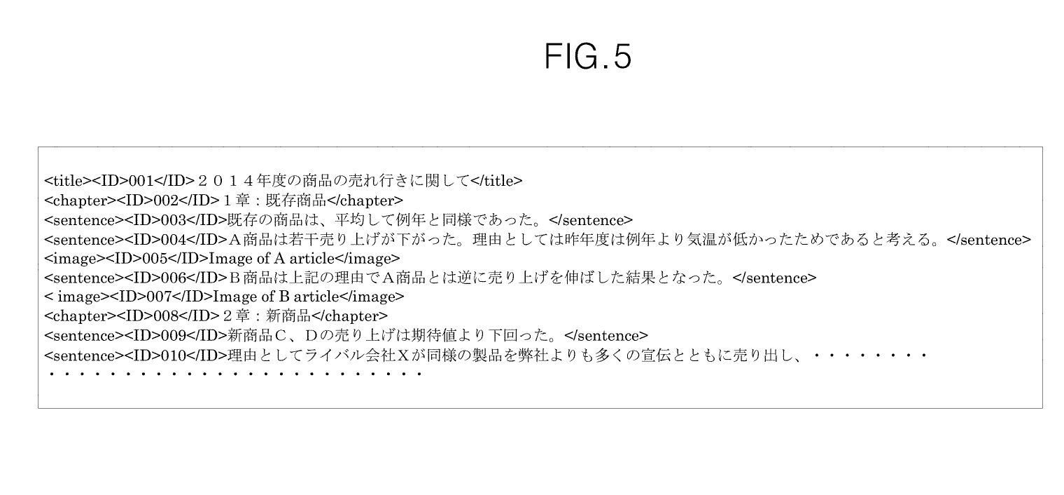

FIG. 5 shows the data of the second document, which is obtained by adding the unique identifiers in the document data shown in FIG. 4. Each unique identifier is a portion enclosed by the tags “ID”, and is a serial number which starts with 001 and is added to each element in the order from the head of the document. The unique identifier is not added to the tag information indicating the format or the like, and is added only to the tag information indicating the entity of the document (the object, such as a sentence, an image and the like).

In this embodiment, the specific information output unit 41 of the presentation terminal outputs the unique identifiers added to the elements in the part which is currently displayed, as the specific information for specifying the displayed part.

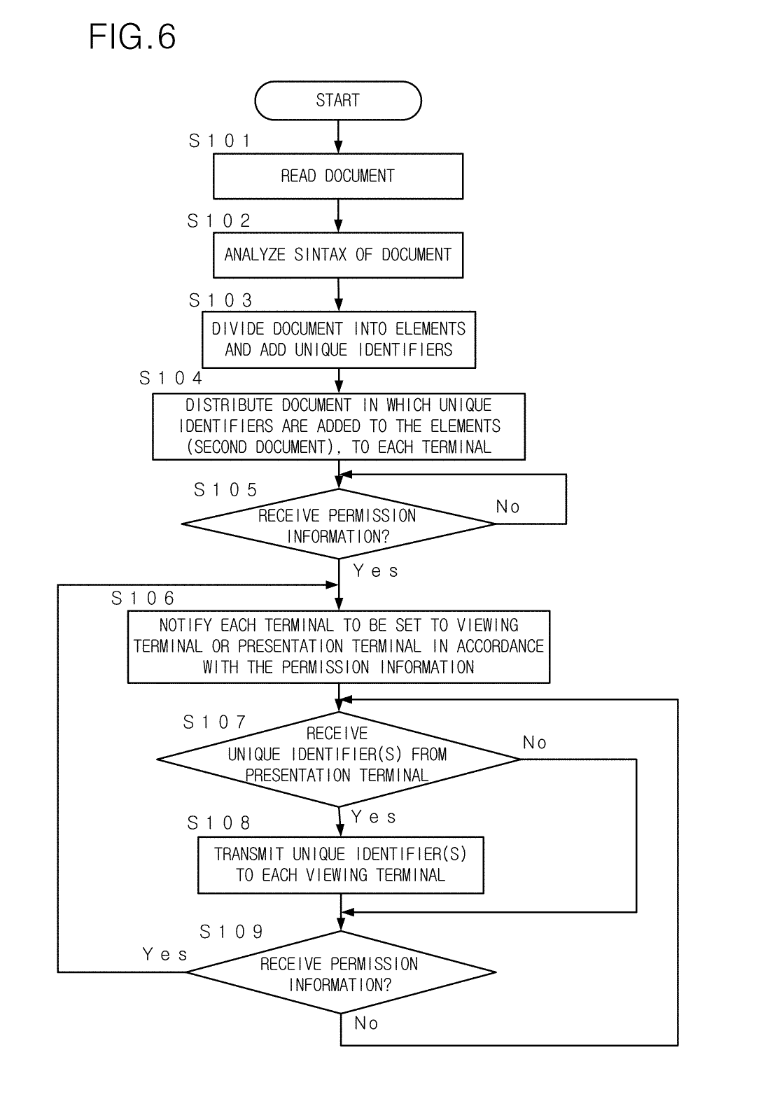

FIG. 6 is a flowchart showing the process for viewing the document, which is carried out by the server 10. Firstly, the server 10 reads the uploaded document (Step S101). The CPU 11 carries out the syntactic analysis for the document (Step S102) and prepares the second document by dividing the document into the elements and adding the unique identifiers (serial numbers) to the elements (Step S103). Then, the server 10 downloads the second document to each participant's display terminal 30 to distribute the second document to the participants of the conference (Step S104).

Then, the server 10 waits for the reception of the permission information from any one of the display terminals 30 (Step S105; No). The permission information is information for specifying the presentation terminal. In this embodiment, the display terminal 30 to be set to the presentation terminal transmits the permission information indicating the request for setting itself to the presentation terminal, to the server 10.

When the server 10 receives the permission information from any one of the display terminal 30 (Step S105; Yes), the server 10 instructs the display terminal 30 which transmits the permission information to operate as the presentation terminal, and instructs the other display terminals 30 to operate as the viewing terminal (Step S106).

When the server 10 receives the unique identifiers as the specific information from the presentation terminal (Step S107; Yes), the server 10 transmits the received specific information (unique identifiers) to the viewing terminals (Step S108).

Further, when the server 10 receives the permission information (Step S109; Yes), the process returns to Step S106 and the server 10 carries out the switch of the presentation terminal by instructing each display terminal 30 to operate as the presentation terminal or the viewing terminal in accordance with the received permission information.

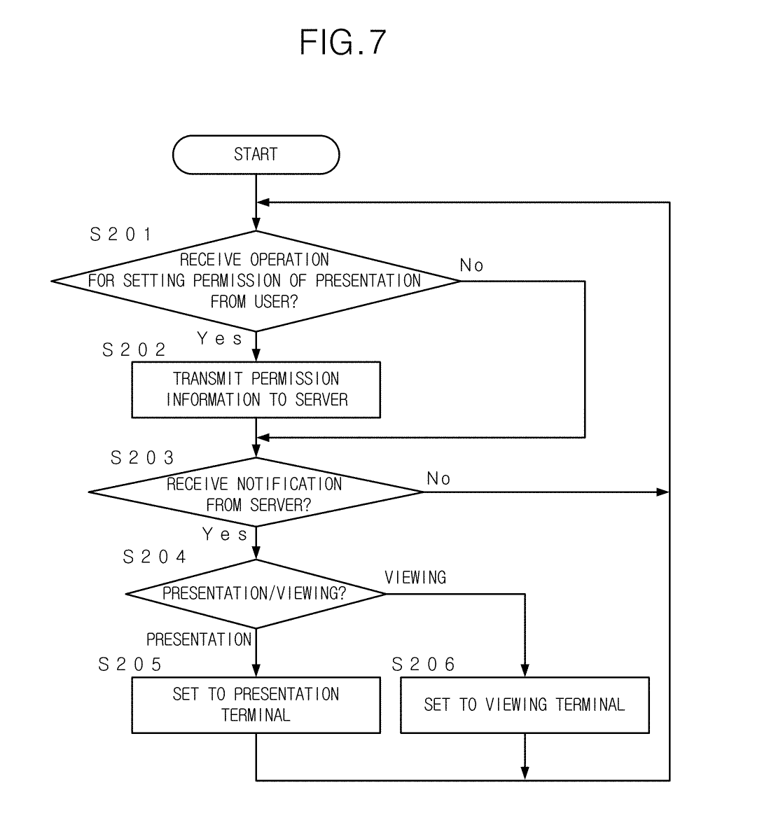

FIG. 7 is a flowchart showing the process for switching the permission between the presentation and the viewing, which is carried out by the display terminal 30. When the display terminal 30 receives the operation for setting the permission of the presentation from the user (Step S201; Yes), the display terminal 30 transmits the permission information including the request for setting itself to the presentation terminal and its own identification information (for example, address information) to the server 10 (Step S202).

In case that the display terminal 30 receives the information relating to the presentation or the viewing from the server 10 (Step S203; Yes), when the received information indicates that the display terminal 30 is instructed to operate as the presentation terminal (Step S204; presentation), the display terminal 30 sets itself to the presentation terminal (Step S205). On the other hand, when the information received from the server 10 indicates that the display terminal 30 is instructed to operate as the viewing terminal (Step S204; viewing), the display terminal 30 sets itself to the viewing terminal (Step S206).

Each display terminal 30 handles the switching of the presentation terminal and the viewing terminal at an optional timing by repeating the above process.

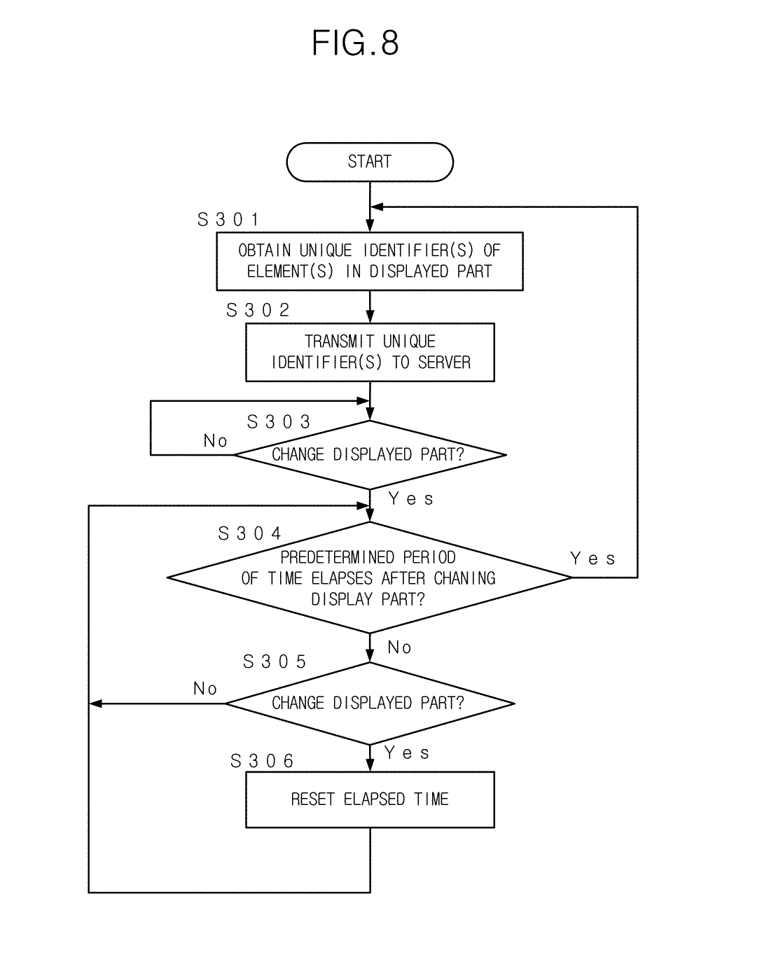

FIG. 8 is a flowchart showing the process which is carried out by the display terminal 30 which becomes the presentation terminal. This process is carried out when the second document downloaded from the server 10 is displayed in accordance with the user's scroll operation and/or the user's magnification/reduction operation.

Firstly, the display terminal 30 obtains all of the unique identifiers attached to the elements of the second document, which are currently displayed thereon (Step S301). In detail, the unique identifier attached to each element, such as the sentence, the image and the like, which is wholly displayed is obtained. Further, the unique identifier attached to each element which is partially displayed, for example, a sentence of which only an end portion is displayed at the upper part of the screen, a sentence of which only a head portion is displayed at the lower part of the screen, and the like, is obtained.

The display terminal 30 which operates as the presentation terminal transmits the obtained unique identifiers to the server 10 as the specific information of the part which is currently displayed (Step S302). Because the serial numbers are attached as the unique identifiers in the order from the head of the document, the display terminal 30 may transmit two unique identifiers which are the first and the last unique identifiers among the obtained unique identifiers, as the specific information. Alternatively, the display terminal 30 may transmit the first unique identifier and the number of the obtained unique identifiers as the specific information.

Then, the display terminal 30 monitors whether the displayed part is changed (Step S303). When the displayed part is changed (Step S303; Yes) and the predetermined period of time elapses since the changed displayed part is not moved after the displayed part is changed (Step S304; Yes), the process returns to Step S301 and is continued. In case that the operation for changing the displayed part is received before the predetermined period of time elapses after the displayed part is changed (Step S305; Yes), the elapsed time is reset (Step S306) and the process returns to Step S304 and is continued.

By carrying out the above process, the displayed part is changed. Then, when the changed displayed part is maintained for the predetermined time, the specific information for specifying the changed displayed part is transmitted to the server 10. As a result, for example, in case that the displayed part is frequently changed by repeating the scroll operation to search the intended part to be displayed, the specific information for specifying the displayed part is prevented from being frequently transmitted to the server 10.

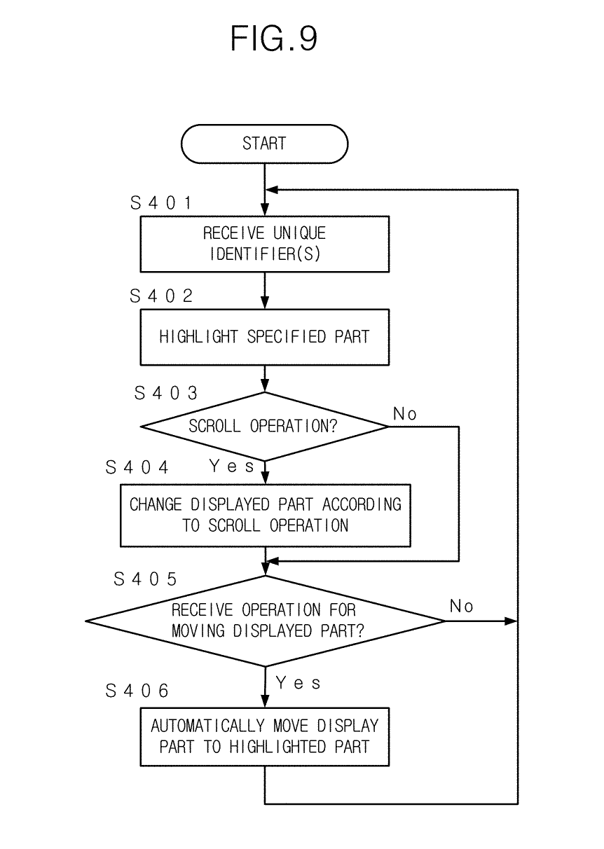

FIG. 9 is a flowchart showing the process which is carried out by the display terminal 30 which becomes the viewing terminal. When the display terminal 30 receives the unique identifiers as the specific information from the server 10 (Step S401), the display terminal 30 highlights the elements, such as the sentence, the image and the like, which have the received unique identifiers (Step S402).

When the display terminal 30 receives the user's operation, such as the scroll operation or the like (Step S403; Yes), the display terminal 30 changes the displayed part in accordance with the received operation (Step S404). In case that the display terminal 30 receives the user's operation for moving the displayed part to the part specified by the unique identifiers received from the server 10 (that is, the highlighted part) (Step S405; Yes), the display terminal 30 automatically move the displayed part so as to display the part of the second document, which is specified by the unique identifiers received from the server 10 (highlighted part) (Step S406).

Next, as the example of the operation of the document viewing system 2, the case in which the document used in the conference is displayed on the three display terminals 30 which are the terminals A, B and C at the same time, will be explained.

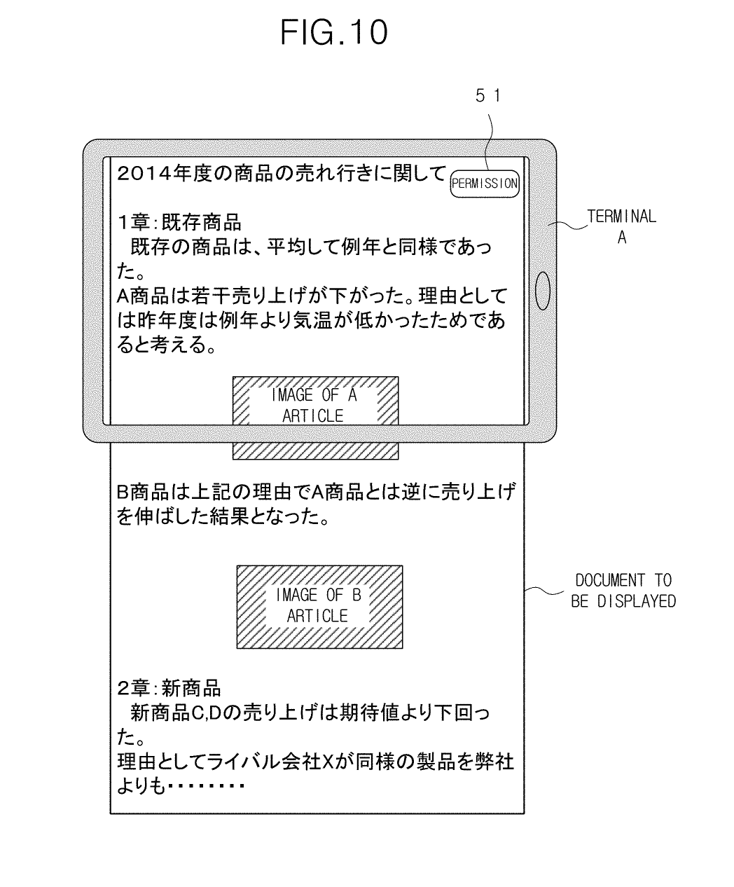

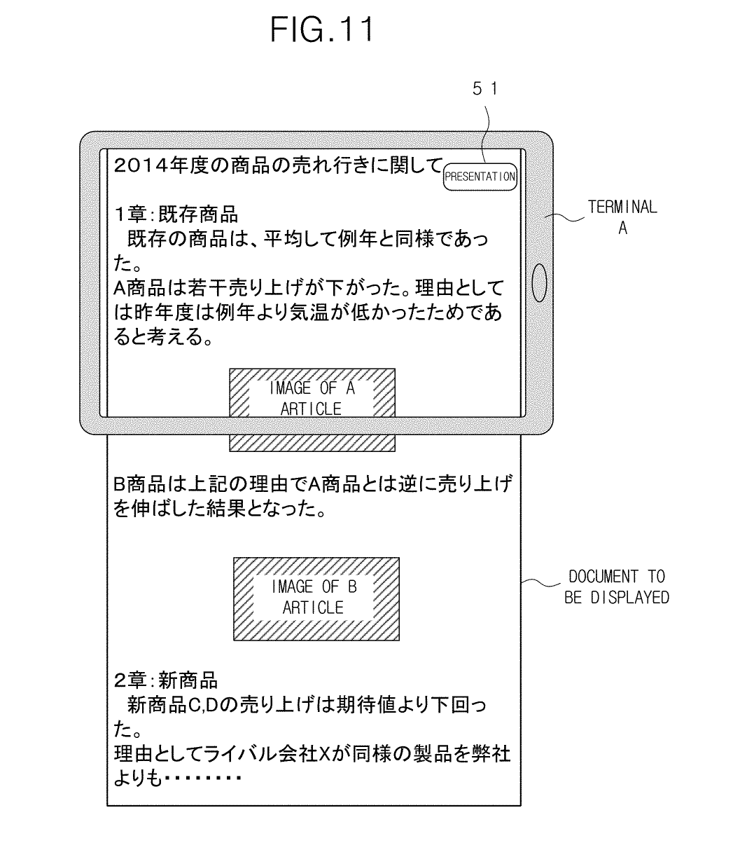

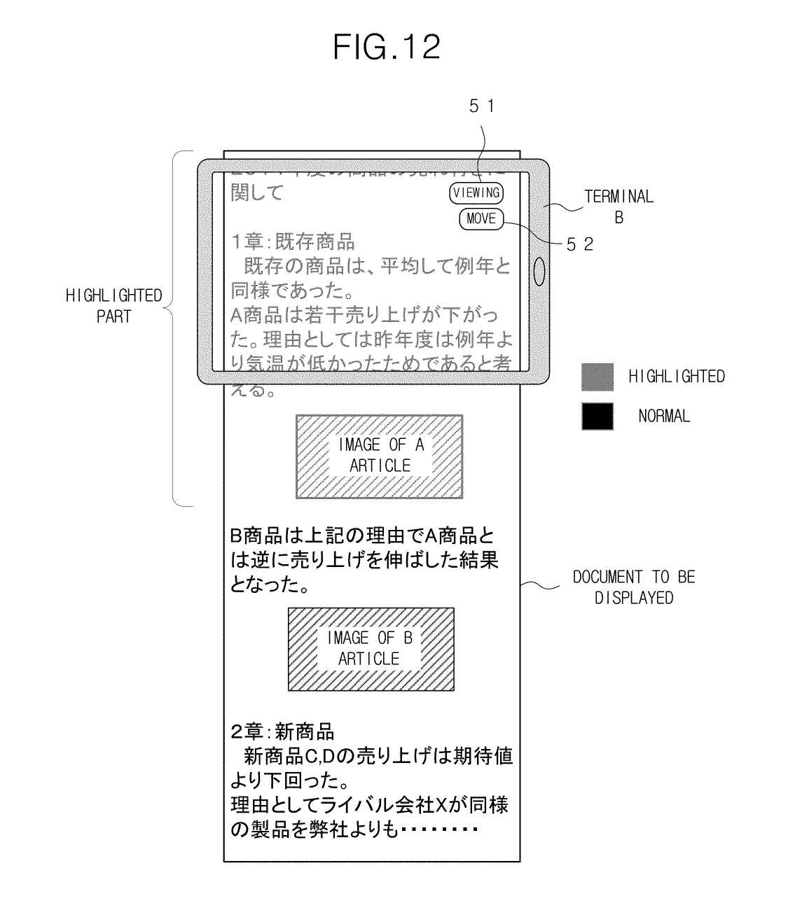

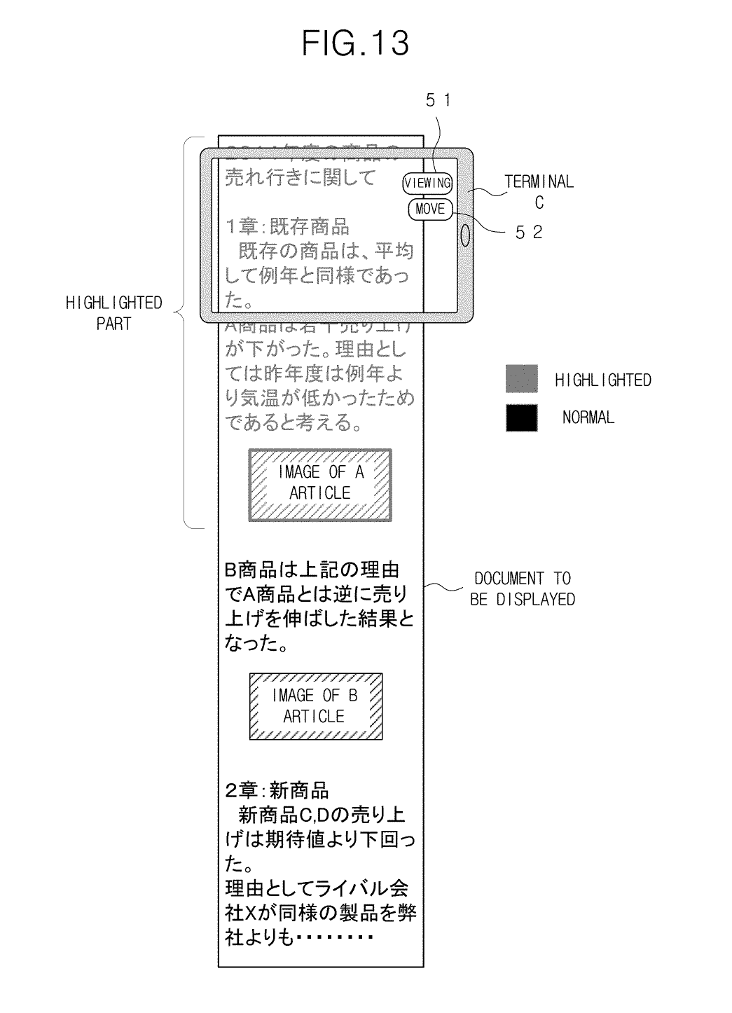

FIG. 10 shows the initial situation in which the second document is displayed on the terminal A. In order to set the terminal A to the presentation terminal and set the terminal B and the terminal C to the viewing terminal, the user of the terminal A presses down the permission switching button 51 displayed on the display screen of the terminal A to change the permission thereof to “presentation”. Thereby, the terminal B and the terminal C are set to the viewing terminal. FIG. 11 shows the situation in which the terminal A becomes the presentation terminal. FIG. 12 shows the situation in which the terminal B becomes the viewing terminal. FIG. 13 shows the situation in which the terminal C becomes the viewing terminal.

In the terminal A shown in FIG. 11, the displayed elements are the title “2014 [symbol] [symbol] ” (Regarding sales of articles in 2014 fiscal year) (unique identifier: 001), the caption “1 [symbol] : [symbol] ” (Chapter 1: Existing articles) (unique identifier: 002), the sentence “ [symbol] ° [symbol] [symbol] ” [symbol] ” (The average of the sales of the existing articles is as usual) (unique identifier: 003), the sentence “A [symbol] [symbol] [symbol] [symbol] [symbol] [symbol] [symbol] ” (The sale of the A article is slightly decreased. The reason for this is that it is considered that in the last fiscal year, the temperature was lower than usual.) (unique identifier: 004) and the image of the A article (unique identifier: 005).

Therefore, the unique identifiers 001 to 005 are transmitted as the specific information from the terminal A to the server 10. Then, the above unique identifiers are transmitted from the server 10 to the terminal B and the terminal C which are the viewing terminals. Alternatively, the above unique identifiers may be transmitted directly from the terminal A to the terminal B and the terminal C.

Each of the terminal B and the terminal C highlights the part specified by the specific information (unique identifiers) received from the server 10. In each of the terminal B and the terminal C which become the viewing terminals, the move button 52 for inputting the instruction for automatically moving the displayed part to the highlighted part is additionally displayed. When a user presses down the move button 52, the displayed part is automatically moved so as to display the highlighted part.

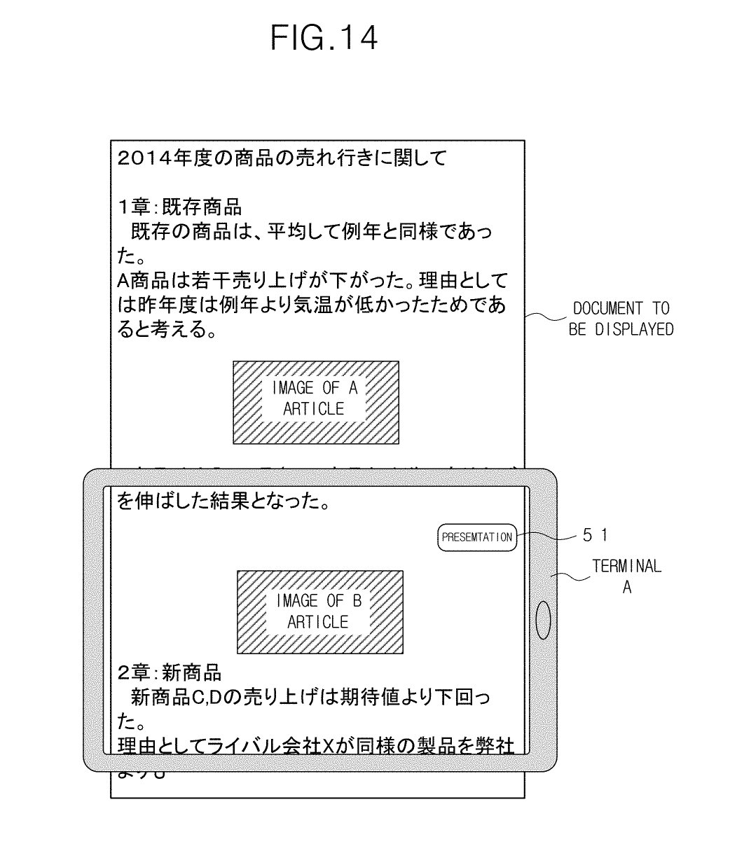

FIG. 14 shows the situation in which after the displayed part is changed by the scroll operation performed by the presenter in the terminal A, the predetermined period of time elapses since the document is displayed at the changed display part. In the situation shown in FIG. 14 (the situation at the timing of the elapse of the predetermined period of time after the displayed part is changed), the elements which are currently displayed on the terminal A are the sentence “B [symbol] [symbol] A [symbol] [symbol] [symbol] ” (The sale of the B article is increased contrary to the A article due to the above reasons.) (unique identifier: 006), the image of the B article (unique identifier: 007), the caption “2: [symbol] : [symbol] ” (Chapter 2: New articles) (unique identifier: 008), the sentence “ [symbol] C, D [symbol] [symbol] [symbol] ” (Each sale of the new articles C and D is lower than the expected value.) (unique identifier: 009) and the sentence “ [symbol] [symbol] [symbol] [symbol] [symbol] . . . ” (As a reason, the competitor X . . . the similar article more than our company (unique identifier: 010).

Therefore, the unique identifiers 0006 to 010 are transmitted as the specific information from the terminal A to the server 10. Then, the above unique identifiers are transmitted from the server 10 to the terminal B and the terminal C which are the viewing terminals. Alternatively, the above unique identifiers may be transmitted directly from the terminal A to the terminal B and the terminal C.

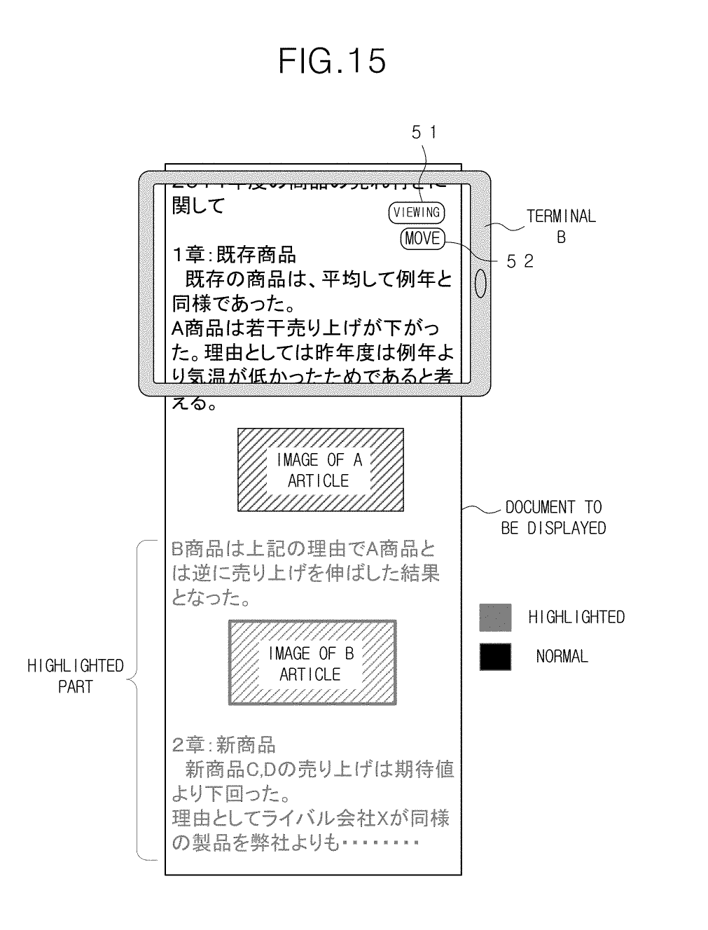

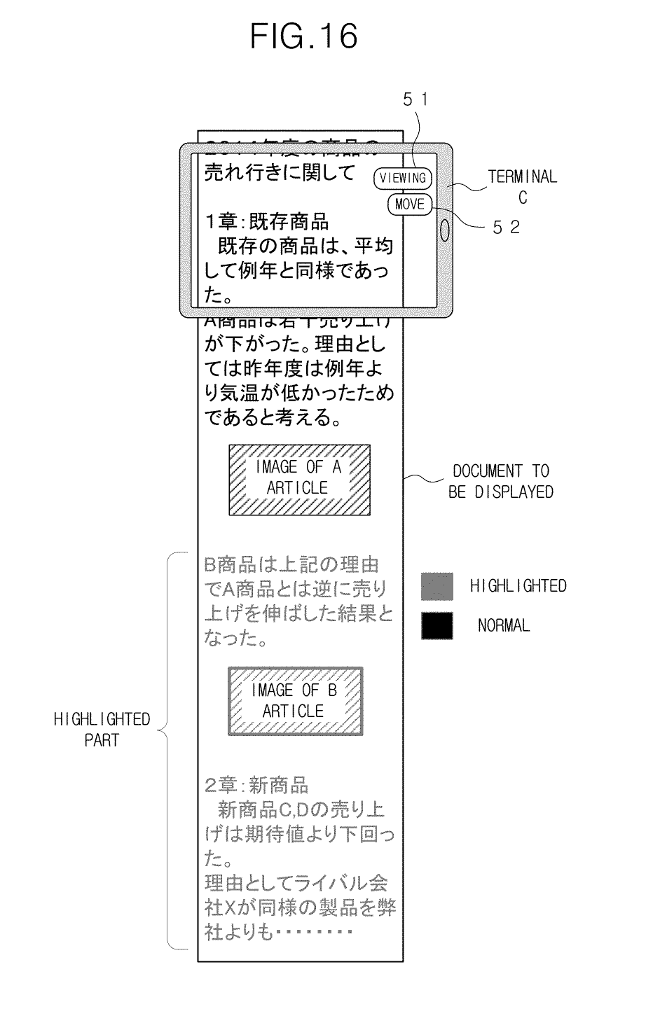

Each of the terminal B and the terminal C changes the highlighted part in accordance with the specific information (unique identifiers) received from the server 10. FIG. 15 shows the situation of the terminal B in which the highlighted part is changed according to the part which is displayed on the terminal A shown in FIG. 14. FIG. 16 shows the situation of the terminal C in which the highlighted part is changed according to the part which is displayed on the terminal A shown in FIG. 14. As compared with FIG. 12 and FIG. 13, each displayed part is not changed, however, each highlighted part is changed.

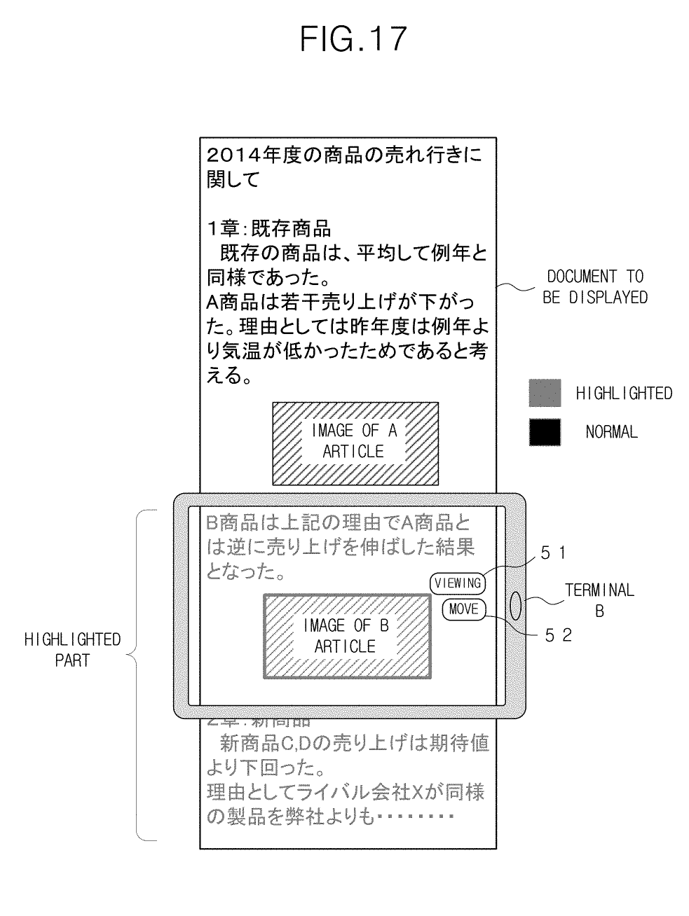

FIG. 17 shows the situation of the terminal B in which the display part is automatically moved to the highlighted part by pressing down the move button 52 in the situation shown in FIG. 15. The displayed part is moved so as to display the head portion of the highlighted part at the upper part of the screen.

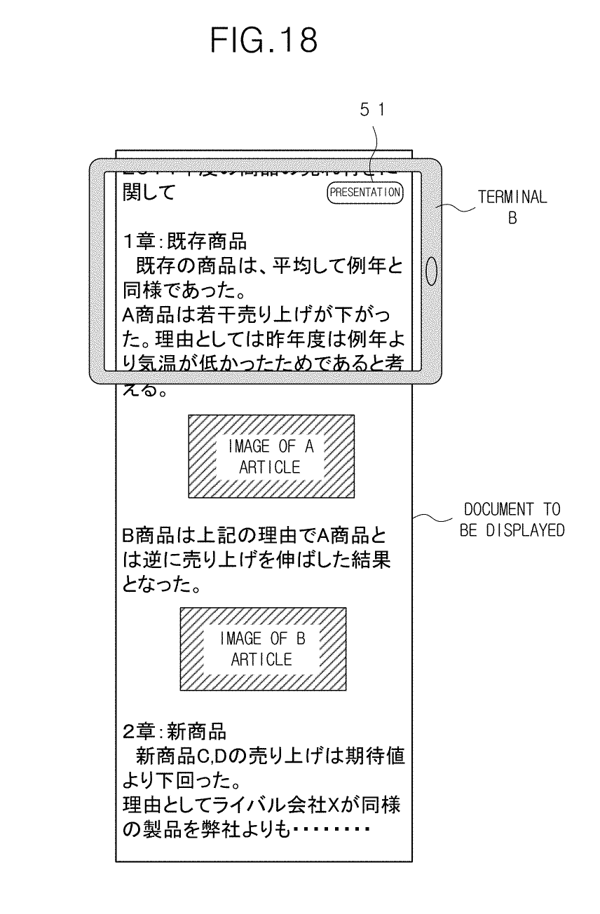

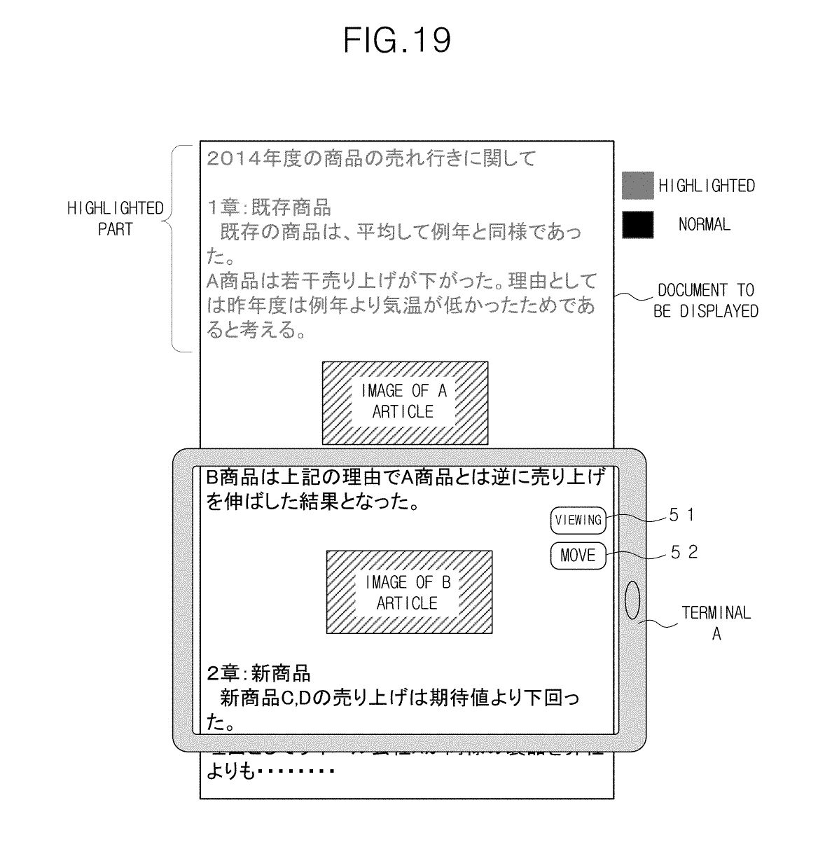

FIG. 18 shows the situation of the terminal B which is switched to the presentation terminal by pressing down the permission switching button 51 in the situation shown in FIG. 15. In case that the user of the terminal B wants to inform each participant of the part which is currently displayed on the terminal B, the permission switching button 51 is operated. By this operation, the terminal B is switched to the presentation terminal, and the terminal A and the terminal C are switched to the viewing terminal. As shown in FIG. 19, in the terminal A, the indication of the permission switching button 51 is switched to the “Viewing”, and the move button 52 is additionally displayed.

The elements which are currently displayed on the terminal B shown in FIG. 18 are the title “2014 [symbol] [symbol] [symbol] ” (Regarding sales of articles in 2014 fiscal year) (unique identifier: 001), the caption “1 [symbol] : [symbol] ” (Chapter 1: Existing articles) (unique identifier: 002), the sentence “ [symbol] [symbol] [symbol] [symbol] ” (The average of the sales of the existing articles is as usual) (unique identifier: 003), and the sentence “A [symbol] [symbol] [symbol] [symbol] [symbol] [symbol] [symbol] ” (The sale of the A article is slightly decreased. The reason for this is that it is considered that in the last fiscal year, the temperature was lower than usual.) (unique identifier: 004). Therefore, the unique identifiers 001 to 004 are transmitted as the specific information from the terminal B to the server 10. Then, the above unique identifiers are transmitted from the server 10 to the terminal A and the terminal C which are the viewing terminals. Alternatively, the above unique identifiers may be transmitted directly from the terminal B to the terminal A and the terminal C.

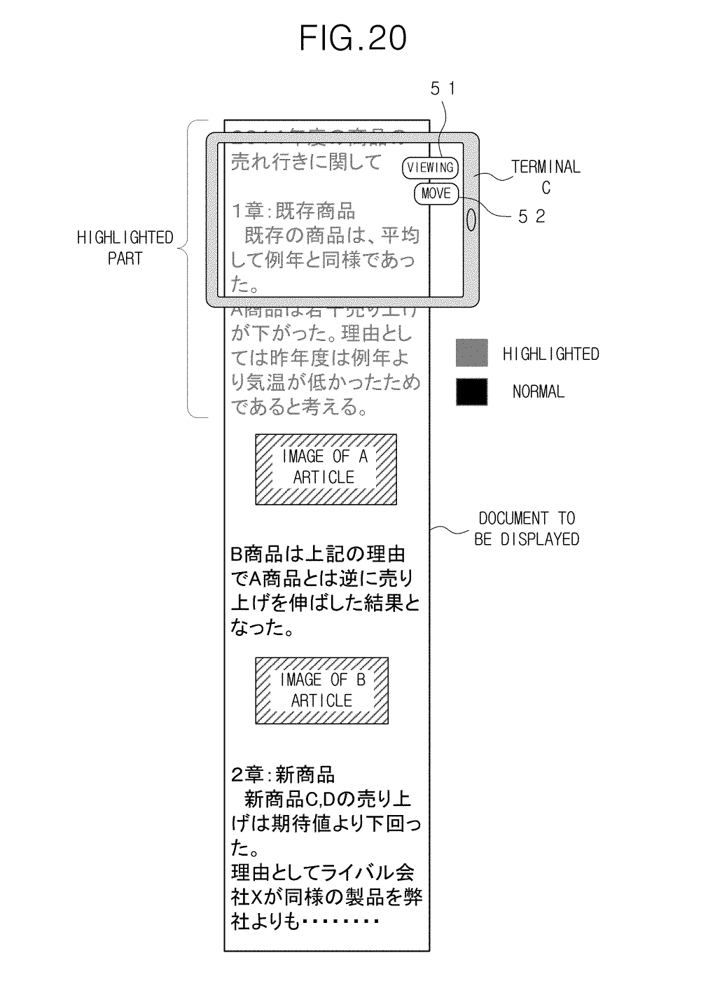

Each of the terminal A and the terminal C changes the highlighted part in accordance with the specific information (unique identifiers) received from the server 10. FIG. 19 shows the situation of the terminal A in which the highlighted part is changed according to the part which is currently displayed on the terminal B shown in FIG. 18. FIG. 20 shows the situation of the terminal C in which the highlighted part is changed according to the part which is currently displayed on the terminal B shown in FIG. 18.

As described above, by operating the permission switching button 51, any one of the terminals can be switched to the presentation terminal.

When each participant wants to edit the document, it is preferable that each participant obtains the document data in which the unique identifiers are not embedded. In such a case, when the request for downloading the original document is transmitted from the terminal to the server 10, the restoring unit 22 of the server 10 restores the original document by deleting the unique identifiers from the second document, and transmits the restored document to the terminal from which the above request is transmitted.

In case that the server 10 stores the original document which is the basis of the second document, the server 10 may transmit the stored original document to the terminal from which the above request is transmitted. Alternatively, the terminal may restore and prepare the original document by deleting the unique identifiers from the second document.

Next, the second embodiment will be explained.

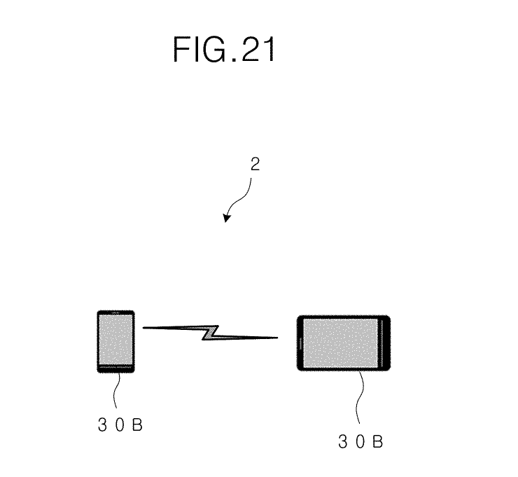

In the first embodiment, the document viewing system 2 comprises the server 10. However, in the second embodiment, as shown in FIG. 21, the document viewing system 2 comprises a plurality of display terminals 30B without including the server 10.

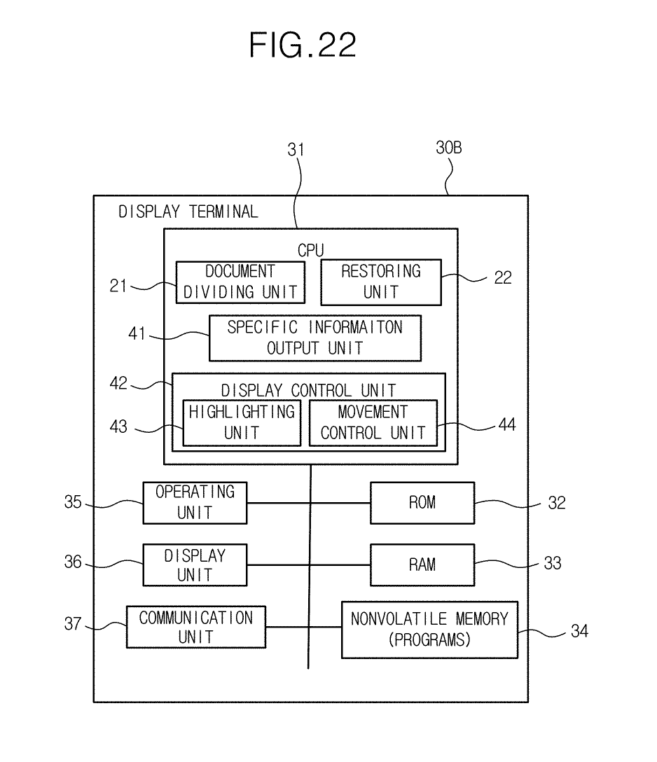

FIG. 22 shows the schematic configuration of the display terminal 30B provided in the document viewing system 2 according to the second embodiment. The hardware configuration thereof is the same as that of the display terminal 30 shown in FIG. 3, and the explanation thereof is omitted accordingly.

In the display terminal 30B, by executing the programs stored in the nonvolatile memory 34, the CPU 31 functions as the document dividing unit 21 and the restoring unit 22 which are the same as those of the server 10 according to the first embodiment, and functions as the specific information output unit 41, the display control unit 42, the highlighting unit 43 and the movement control unit 44 like the display terminal 30 according to the first embodiment.

In addition, the CPU 31 of the display terminal 30B has the function for transmitting the second document prepared by the document dividing unit 21 to the other display terminals 30B, the function for notifying the other display terminals 30B that the display terminal 30B itself becomes the presentation terminal when the operation for setting itself to the presentation terminal is received from a user, the function for setting itself to the viewing terminal when the notification indicating that another display device 30B becomes the presentation terminal is received, and the like.

In case that the display terminal 30B becomes the presentation terminal, the display terminal 30B creates the specific information for specifying the part of the second document, which is currently displayed on the display unit 36 thereof, in accordance with the unique identifiers added in the second document, and transmits the specific information to the other display terminals 30B (viewing terminals).

When the display terminal 30B which is set to the viewing terminal displays the second document, the display control unit 42 specifies the part which is currently displayed on the presentation terminal, in accordance with the specific information received from the presentation terminal, and displays the second document on the above display terminal 30B set to the viewing terminal so as to make a viewer recognize the specified part. Specifically, the highlighting unit 43 highlights the specified part, and the movement control unit 44 automatically moves the displayed part to the specified part.

As described above, in the second embodiment, the same effect as that of the first embodiment can be obtained.

As described above, the embodiments are explained by using the drawings. However, in the present invention, the concrete configuration is not limited to the above embodiments. In the present invention, various modifications of the above embodiments or the addition of various functions or the like to the embodiments can be carried out without departing from the gist of the invention.

In at least one of the embodiments, the second document in which the unique identifier is added to each element of the document as the specific information, is prepared. However, the second document in which the common identifier indicating the element of the document (such as the sentence, the title, the image and the like to be displayed) is added to each element, may be prepared. In this case, the specific information output unit 41 specifies the elements of the document in the part which is currently displayed, and counts the number of the identifiers from the head of the document to check how many identifiers are there between the head of the document and the identifier attached to one of the elements which are currently displayed. Then, the specific information output unit 41 creates the specific information indicating the number of the identifiers between the head of the document and the identifier attached to the above one element which is currently displayed, and transmits the created specific information to the server 10 or the viewing terminals. In the viewing terminal, the CPU 31 counts the identifiers from the head of the second document and highlights the elements in the part in which the number indicated in the received specific information is coincident with the counted number of the identifiers, as the elements which are currently displayed on the presentation terminal.

In at least one of the embodiments, when the operation for the move button 52 is received from a user, the displayed part is moved so as to display the highlighted part. However, when the specific information is received from the server 10 or the presentation terminal, the displayed part may be automatically moved so as to display the highlighted part according to the specific information without receiving the operation for the move button 52 from a user.

In at least one of the embodiments, in case that the document is divided into the elements, the tag information is used. However, for example, the sentence is divided in units of the optional number of characters (for example, 100 characters) as the element of the document. Then, the identifier or the unique identifier may be added to each element.

The technology disclosed in the above embodiments may be applied to the program to be executed by an information processing device to function as the server 10 or the display terminal 30.

One of the objects of the above embodiments is to provide a document viewing system and a non-transitory computer-readable recording medium which can easily recognize the part which is currently displayed on one terminal, in another terminal when a plurality of terminals display the same document in the reflow display.

In at least one of the embodiments or the like, the document dividing unit analyzes the structure of the document, such as the XML document or the like, divides the document into the elements, such as a sentence, a drawing, an image and the like, and prepares the second document by adding the identifiers to the elements. The first display terminal which is one of a plurality of display terminals for displaying the second document in the reflow display, creates the specific information for specifying the part of the second document, which is currently displayed on the first display terminal, in accordance with the identifiers added in the second document, and outputs the specific information to an external device. The second display terminal which is another display terminal of the plurality of display terminals, receives the specific information and displays the second document so as to make a viewer recognize the part which is currently displayed on the first display terminal in accordance with the specific information. For example, the part specified in accordance with the specific information is highlighted. Alternatively, the part which is displayed on the second display terminal is automatically moved to the part specified in accordance with the specific information. In the document viewing system, the document dividing unit may be included in the server or the like on the network, or one of the display terminals may have the function of the document dividing unit.

In at least one of the embodiments or the like, by adding the unique identifiers to the elements of the document, the element in the part which is currently displayed can be easily specified.

In at least one of the embodiments or the like, by scrolling the window, a user can easily find the highlighted part, that is, the part which is currently displayed on the first display terminal.

In at least one of the embodiments or the like, in the second display terminal, the part which is currently displayed is automatically moved to the part which is currently displayed on the first display terminal. The trigger for automatically moving the part which is currently displayed may be received from a user.

In at least one of the embodiments or the like, the part which is displayed on the second display terminal is automatically moved so as to follow the change in the part which is currently displayed on the first display terminal.

In at least one of the embodiments or the like, in case that the displayed part is frequently changed by the scroll operation or the like, the specific information is prevented from being frequently output due to the frequent change in the displayed part.

In at least one of the embodiments or the like, the original document can be restored. The restoration of the document is effective for the case in which the document is used individually.

In at least one of the embodiments or the like, by executing the program, the information processing device has the function for preparing the second document in which the identifiers are added to the elements of the document and transmitting the second document to the display terminals. For example, this program is executed in the server of the document viewing system on the network, or is executed by being installed in the display terminal.

In at least one of the embodiments or the like, by executing the program, the information processing device has the function for obtaining the second document from an external device, and outputting the specific information for specifying the part which is currently displayed by the information processing device to an external device. For example, this program is executed by being installed in the display terminal of the document viewing system.

According to the document viewing system and the non-transitory computer-readable recording medium, it is possible to easily recognize the part which is currently displayed on one terminal, in another terminal when a plurality of terminals display the same document in the reflow display.

What is claimed is:

1. A document viewing system, comprising:
a document dividing unit analyzing a format of a document to be displayed in a reflow display, dividing the document into predetermined elements, and preparing a second document by adding identifiers to the elements; and
a plurality of display terminals displaying the second document in the reflow display, the plurality of display terminals including a first display terminal and a second display terminal,
wherein the first display terminal creates specific information for specifying a part of the second document, which is currently displayed on the first display terminal, in accordance with the identifiers added in the second document, and outputs the specific information to an external device, and
the second display terminal receives the specific information, specifies the part which is currently displayed on the first display terminal in accordance with the specific information, and displays the second document so as to make a viewer recognize the specified part.

2. The document viewing system of claim 1, wherein the document dividing unit prepares the second document in which unique identifiers are added to the elements, and
the first display terminal outputs the unique identifier added to each element in the part which is currently displayed on the first display terminal, as the specific information.

3. The document viewing system of claim 1, wherein the second display terminal highlights the part specified in accordance with the specific information, to make the viewer recognize the specified part.

4. The document viewing system of claim 1, wherein the second display terminal moves a second part of the second document, which is displayed on the second display terminal, to the part specified in accordance with the specific information, to make the viewer recognize the specified part.

5. The document viewing system of claim 4, wherein when the second display terminal receives an operation for moving the second part displayed on the second display terminal from the viewer, the second display terminal automatically moves the second part displayed on the second display terminal to the part specified in accordance with the specific information.

6. The document viewing system of claim 4, wherein every when the second display terminal receives the specific information, the second display terminal automatically move the second part of the second document, which is displayed on the second display terminal, to the part specified in accordance with the specific information.

7. The document viewing system of claim 1, wherein the document dividing unit divides the document by recognizing the elements from tag information for defining a structure of the document.

8. The document viewing system of claim 1, wherein after the part of the document, which is displayed on the first display terminal is moved, when the moved part continues to be displayed for a predetermined period of time, the first display terminal creates and outputs the specific information.

9. The document viewing system of claim 1, wherein the display terminal which functions as the first display terminal is switched to another display terminal among the plurality of display terminals.

10. The document viewing system of claim 1, further comprising: a restoring unit restoring the document by deleting the identifiers added in the second document.

11. A non-transitory computer-readable recording medium in which a program is stored, wherein the program causes an information processing device, to:
analyze a format of a document to be displayed in a reflow display, divide the document into predetermined elements, and prepare a second document by adding identifiers to the elements; and
send the second document to a plurality of display terminals displaying the second document in the reflow display.

12. The non-transitory computer-readable recording medium of claim 11, wherein the program causes the information processing device to prepare the second document in which unique identifiers are added to the elements.

13. The non-transitory computer-readable recording medium of claim 11, wherein the program causes the information processing device to divide the document by recognizing the elements from tag information for defining a structure of the document.

14. The non-transitory computer-readable recording medium of claim 11, wherein the program causes the information processing device to restore the document by deleting the identifiers added in the second document.

15. A non-transitory computer-readable recording medium in which a program is stored, wherein the program causes an information processing device, to:
obtain a second document prepared by analyzing a format of a document to be displayed in a reflow display, dividing the document into predetermined elements, and adding identifiers to the elements; and
create specific information for specifying a part of the second document, which is currently displayed on the information processing device, in accordance with the identifiers added in the second document and output the specific information to an external device when the information processing device displays the second document in the reflow display.

16. The non-transitory computer-readable recording medium of claim 15, wherein after the part of the document, which is displayed on the information processing device is moved, when the moved part continues to be displayed for a predetermined period of time, the program causes the information processing device to create and output the specific information.
